(19) United States
(12) Patent Application Publication
(10) Pub. No.: US 2009/0106026 A1
(43) Pub. Date: Apr. 23, 2009

(54) Speech recognition method, device, and computer program

(75) Inventor: Alexandre Ferrieux, Pleumeur Bodou (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/921,288

(22) PCT Filed: May 24, 2006
(86) PCT No.: PCT/FR2006/001197

§ 371 Date: Apr. 24, 2008

(30) Foreign Application Priority Data
May 30, 2005 (FR) 0505451

(51) Int. Cl. G10L 15/18; G10L 15/00

(52) U.S. Cl. 704/251; 704/257; 704/E15.018; 704/E15.005

(57) ABSTRACT

A speech recognition method including for a spoken expression: a) providing a vocabulary of words including predetermined subsets of words, b) assigning to each word of at least one subset an individual score as a function of the value of a criterion of the acoustic resemblance of that word to a portion of the spoken expression, c) for a plurality of subsets, assigning to each subset of the plurality of subsets a composite score corresponding to a sum of the individual scores of the words of said subset, d) determining at least one preferred subset having the highest composite score.

The invention relates to the field of speech recognition.

An expression spoken by a user generates an acoustic signal that can be converted into an electrical signal to be processed. However, in the remainder of the description, any signal representing the acoustic signal is referred to either as the “acoustic signal” or as the “spoken expression”.

The words spoken are retrieved from the acoustic signal and a vocabulary. In the present description, the term “word” designates both words in the usual sense of the term and expressions, i.e. series of words forming units of sense.

The vocabulary comprises words and an associated acoustic model for each word. Algorithms well known to the person skilled in the art allow to identifying acoustic models from a spoken expression. Each identified acoustic model corresponds to a portion of the spoken expression.

In practice, several acoustic models are commonly identified for a given acoustic signal portion. Each acoustic model identified is associated with an acoustic score. For example, two acoustic models associated with the words “back” and “black” might be identified for a given acoustic signal portion. The above method, which chooses the acoustic model associated with the highest acoustic score, cannot correct an acoustic score error.

It is known in the art to use portions of acoustic signals previously uttered by a user to estimate the word corresponding to a given acoustic signal portion more reliably. Thus if a previously-uttered acoustic signal portion has a high chance of corresponding to the word “cat”, the word “black” can be deemed to be correct, despite being associated with a lower acoustic score than the word “back”. Such a method can be used by way of a Markov model: the probability of going from the word “black” to the word “cat” is higher than the probability of going from the word “back” to the word “cat”. Sequential representations of the words identified, for example a tree or a diagram, are commonly used.

The algorithms used, for example the Viterbi algorithm, involve ordered language models, i.e. models sensitive to the order of the words. The reliability of recognition therefore depends on the order of the words spoken by the user.

For example, an ordered language model may evaluate the probability of going from the word “black” to the word “cat” as non-zero as a consequence of a learning process, and may evaluate the probability of going in the opposite direction from the word “cat” to the word “black” as zero by default. Thus, if the user speaks the expression “the cat is black”, the estimated acoustic model of each acoustic signal portion uttered has a higher risk of being incorrect than if the user had spoken the expression “black is the cat”.

Of course, it is always possible to inject commutativity into an ordered language model, but the use of such a method runs the risk of being difficult because of its complexity.

The present invention improves on this situation in particular in that it achieves reliable speech recognition that is less sensitive to the order of the words spoken.

The present invention relates to a speech recognition method including the following steps for a spoken expression:

a) providing a vocabulary of words including predetermined subsets of words;

b) assigning to each word of at least one subset an individual score as a function of the value of a criterion of acoustic resemblance of that word to a portion of the spoken expression;

c) for a plurality of subsets, assigning to each subset of the plurality of subsets a composite score corresponding to a sum of the individual scores of the words of that subset; and

d) determining a preferred subset having the highest composite score.

Accordingly, in the step d), at least one subset with a higher composite score is selected as the subset including candidate best words independently of the order of said candidate best words in the spoken expression.

The method according to the present invention involves a commutative language model, i.e. one defined by the co-occurrence of words and not their ordered sequence. Addition being commutative, the composite score of a subset, as a cumulative sum of individual scores, depends only on the words of that subset and not at all on their order.

The invention finds a particularly advantageous application in the field of spontaneous speech recognition, in which the user benefits from total freedom of speech, but is naturally not limited to that field.

It must be remembered that in the present description the term “word” designates both an isolated word and a expression.

Each word from the vocabulary is preferably assigned an individual score during step (b). In this way all the words of the vocabulary are scanned.

In step (c), the subsets in the plurality of subsets are advantageously all subsets of the vocabulary (the composite score of a subset can naturally be zero).

The individual score attributed to each word is a function of the value of a criterion of the acoustic resemblance of that word to a portion of the spoken expression, for example the value of an acoustic score. Thus the individual score can be equal to the corresponding acoustic score.

Alternatively, the individual score can take only binary values. If the acoustic score of a word from the vocabulary exceeds a certain threshold, the individual score attributed to that word is equal to 1. If not, the individual score attributed to that word is equal to 0. Such a method enables relatively fast execution of step (c).

The composite score of a subset can simply be the sum of the individual scores of the words of that subset. Alternatively, the sum of the individual scores can be weighted, for example by the duration of the corresponding words in the spoken expression.

The subsets of words from the vocabulary are advantageously constructed prior to executing steps (b), (c), and (d). All the subsets constructed beforehand are then held in memory, which enables relatively fast execution of steps (b), (c), and (d). Moreover, such a method enables the words of each subset constructed beforehand to be chosen beforehand.

The method according to the invention can include in step (d) the selection of a short list comprising a plurality of preferred subsets. A step (e) of determining the candidate best subset may be executed. Under such circumstances, because of their fast execution, steps (a), (b), (c), and (d) are executed first to determine the preferred subsets. Because of the relatively small number of preferred subsets, step (e) may use a relatively complex algorithm. Thus the constraint of forming a valid path in a sequential representation, for example a tree or a diagram, may be applied to the words of each preferred subset to end up by choosing the candidate best subset.

Alternatively, a single preferred subset is determined in step (d): the reliability of speech recognition is then exactly the same regardless of the order in which the words were spoken.

The present invention further consists in a computer program product for recognition of speech using a vocabulary. The computer program product is adapted to be stored in a memory of a central unit and/or stored on a memory medium adapted to cooperate with a reader of said central unit and/or downloaded via a telecommunications network. The computer program product according to the invention comprises instructions for executing the method described above.

The present invention further consists in a device for recognizing speech using a vocabulary and adapted to implement the steps of the method described above. The device of the invention comprises means for storing a vocabulary comprising predetermined subsets of words. Identification means assign an individual score to each word of at least one subset as a function of the value of a criterion of resemblance of that word to at least one portion of the spoken expression. Calculation means assign a composite score to each subset of a plurality of subsets, each composite score corresponding to a sum of individual scores of the words of that subset. The device of the invention also comprises means for selecting at least one preferred subset with the highest composite score.

Other features and advantages of the present invention become apparent in the following description.

FIG. 1 shows by way of example an embodiment of a speech recognition device of the present invention.

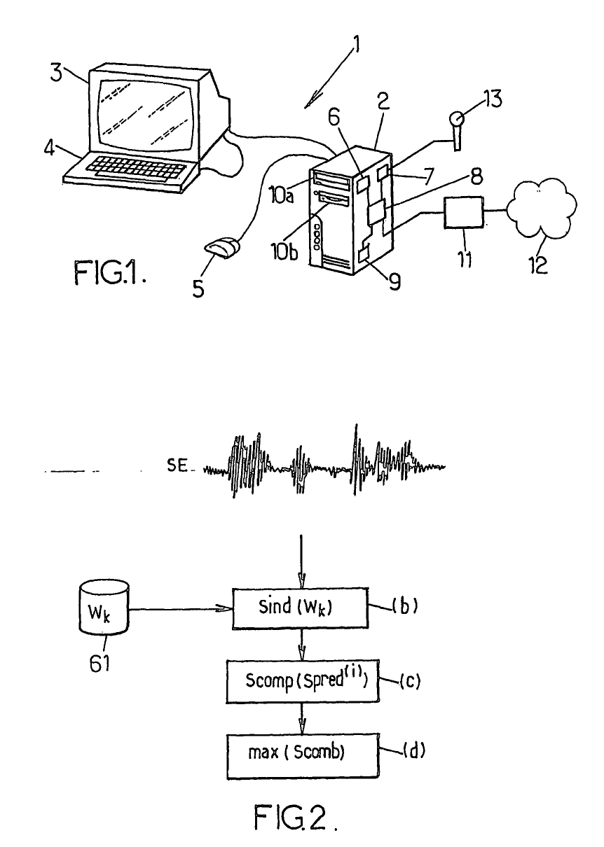

FIG. 2 shows by way of example a flowchart of an implementation of a speech recognition method of the present invention.

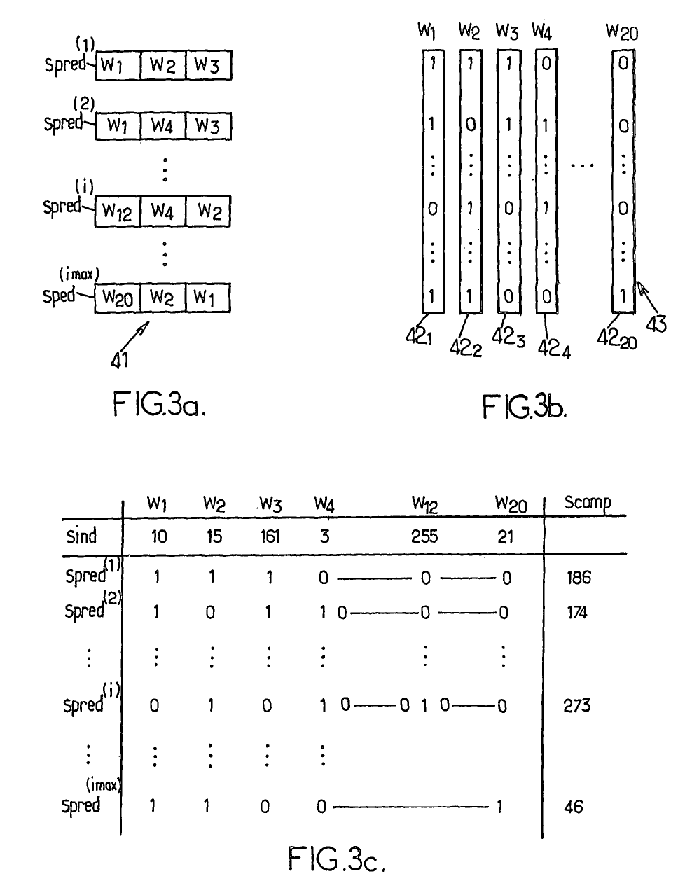

FIG. 3a shows, by way of example, a base of subsets of a vocabulary conforming to an implementation of the present invention.

FIG. 3b shows, by way of example, a set of indices used in an implementation of the present invention.

FIG. 3c shows, by way of example, a table for calculating composite scores of subsets in an implementation of the present invention.

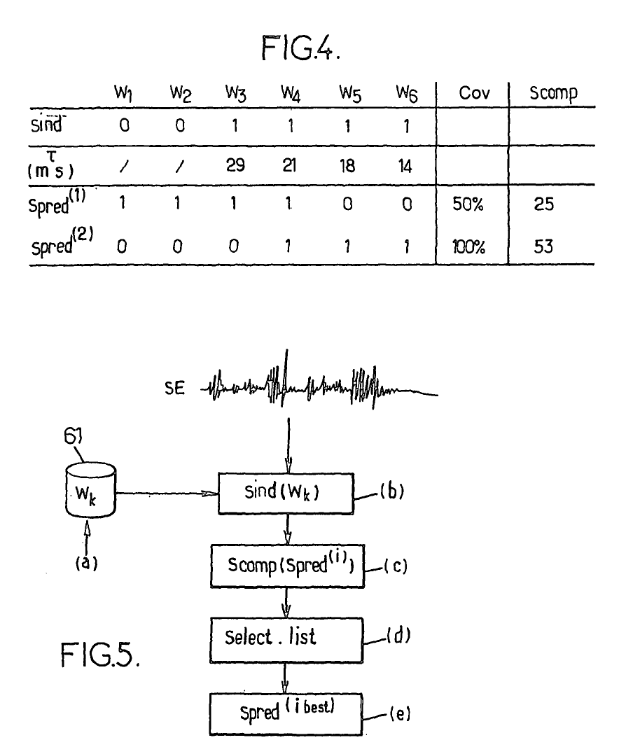

FIG. 4 shows, by way of example, another table for calculating composite scores of subsets in an implementation of the present invention.

FIG. 5 shows, by way of example, a flowchart of an implementation of a speech recognition method of the present invention.

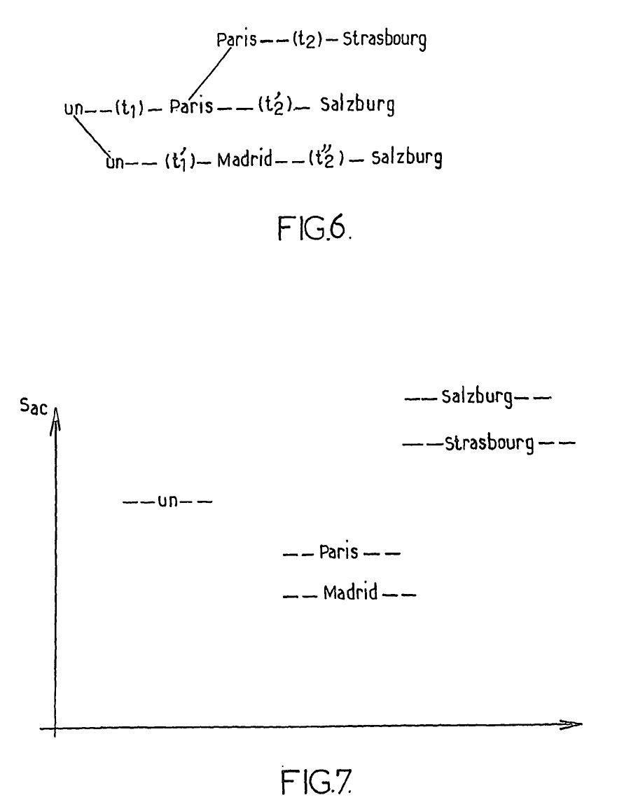

FIG. 6 shows, by way of example, a tree that can be used to execute an implementation of a speech recognition method of the present invention.

FIG. 7 shows, by way of example, a word diagram that can be used to execute an implementation of a speech recognition method according to the present invention.

Reference is made initially to FIG. 1, in which a speech recognition device 1 comprises a central unit 2. Means for recording an acoustic signal, for example a microphone 13, communicate with means for processing an acoustic signal, for example a sound card 7. The sound card 7 produces a signal having a format suitable for processing by a microprocessor 8.

A speech recognition computer program product can be stored in a memory, for example on a hard disk 6. This memory also stores the vocabulary. During execution of this computer program by the microprocessor 8, the program and the signal representing the acoustic signal can be stored temporarily in a random access memory 9 communicating with the microprocessor 8.

The speech recognition computer program product can also be stored on a memory medium, for example a diskette or a CD-ROM, intended to cooperate with a reader, for example a diskette reader 10a or a CD-ROM reader 10b.

The speech recognition computer program product can also be downloaded via a telecommunications network 12, for example the Internet. A modem 11 can be used for this purpose.

The speech recognition device 1 can also include peripherals, for example a screen 3, a keyboard 4, and a mouse 5.

FIG. 2 is a flowchart of an implementation of a speech recognition method of the present invention that can be used by the speech recognition device shown in FIG. 1, for example.

A vocabulary 61 comprising subsets S_{pred}⁽ⁱ⁾ of words Wₖ is provided.

In this embodiment, the vocabulary is scanned (step (b)) to assign to each word from the vocabulary an individual score S_{ind}(Wₖ). That individual score is a function of the value of a criterion of acoustic resemblance of this word Wₖ to a portion of a spoken expression SE. The criterion of acoustic resemblance may be an acoustic score, for example. If the acoustic score of a word from the vocabulary exceeds a certain threshold, then that word is considered to have been recognized in the spoken expression SE and the individual score assigned to that word is equal to 1, for example. In contrast, if the acoustic score of a given word is below the threshold, that word is considered not to have been recognized in the spoken expression SE and the individual score assigned to that word is equal to 0. Thus the individual scores take binary values.

Other algorithms can be used to determine individual scores from acoustic resemblance criteria.

In this implementation, to each subset of the vocabulary is assigned a composite score S_{comp}(S_{pred}⁽ⁱ⁾) (step (c)). The composite score S_{comp}(S_{pred}⁽ⁱⁱ⁾) of a subset S_{pred}⁽ⁱ⁾ is calculated by summing the individual scores S_{ind} of the words of that subset. Addition being commutative, the composite score of a subset does not depend on the order in which the words were spoken. That sum can be weighted, or not. It may also be merely a term or a factor in the calculation of the composite score.

Finally, a preferred subset is determined (step (d)). In this example, the subset having the highest composite score is chosen.

Calculation of Composite Scores

FIGS. 3a, 3b, and 3c show one example of a method of calculating the composite scores of subsets that have already been constructed.

FIG. 3a shows a basic example of a base subsets 41. In this example, there are three words in each subset. The vocabulary comprises a number of subsets i_{MAX}. Each subset S_{pred}⁽ⁱ⁾ of the vocabulary comprises three words from the vocabulary Wₖ, in any order. For example, a second subset S_{pred}⁽ⁱ⁾ comprises the words W1, W4 and W3.

A set 43 of indices (42₁, 42₂, 42₃, 42₄, . . . , 42₂₀) may be constructed from the base 41, as shown in FIG. 4b. Each index comprises coefficients represented in columns and is associated with a word (W1, W2, W3, W4, . . . , W20) from the vocabulary. Each row is associated with a subset S_{pred}⁽ⁱ⁾. For a given word Wₖ and a given subset, the corresponding coefficient takes a first value, for example 1, if the subset includes the word Wₖ and a second value, for example 0, if it does not. For example, assuming that the word W3 is included only in a first subset S_{pred}⁽¹⁾ and the second subset S_{pred}⁽²⁾, the coefficients of the corresponding index 42₃ are all zero except for the first and second coefficients situated on the first row and on the second row, respectively.

The set 43 of indices is used to draw up a table, as shown in FIG. 4c. Each column of the table is associated with a word (W1, W2, W3, W4, . . . , W20) from the vocabulary. Each subset S_{pred}⁽ⁱ⁾ of the vocabulary is associated with a row of the table. The table further comprises an additional row indicating the value of an individual score S_{ind} for each column, i.e. for each word. In this example, the individual scores are proportional to the corresponding acoustic scores. The acoustic scores are obtained from a spoken expression.

By summing over the words of the vocabulary (W1, . . . , W20) the values of the individual scores as weighted by the corresponding coefficients of a given row, the composite of the subset corresponding to that row is obtained. Calculation of the scores of the subsets is therefore fast and varies in a linear manner with the size of the vocabulary or with the number of words of the subsets.

Of course, this calculation method is described by way of example only and is no way limiting on the scope of the present invention.

Another Example of Calculation of Composite Scores

FIG. 4 shows another example of a table for calculating composite scores of subsets in one embodiment of the present invention. This example relates to the field of call routing by an Internet service provider.

In this example, the vocabulary comprises six words:
“subscription” (W1);
“invoice” (W2)
“too expensive” (W3);
“Internet” (W4);
“is not working” (W5); and
“network” (W6).

Only two subsets are defined: a first subset that can contain “subscription”, “invoice”, “Internet”, and “too expensive”, for example, and a second subset that can contain “is not working”, “Internet”, and “network”, for example. If, during a client's telephone call, the method of the present invention determines that the first subset is the preferred subset, the client is automatically routed to an accounts department, and if it determines that the second subset is the preferred subset, then the client is automatically routed to a technical department.

Each column of the table is associated with a word (W1, W2, W3, W4, W5, W6) from the vocabulary. Each subset (S_{pred}⁽¹⁾, S_{pred}⁽²⁾) from the vocabulary is associated with a row of the table.

The table further comprises two additional rows.

A first additional row indicates the value of an individual score S_{ind} for each column, i.e. for each word. In this example, the individual scores take binary values.

A second additional row indicates the value of the duration of each word in the spoken expression. This duration can be measured during the step (b) of assigning to each word an individual score. For example, if the value of a criterion of acoustic resemblance for a given word to a portion of the spoken expression reaches a certain threshold, the individual score takes a value equal to 1 and the duration of this portion of the spoken expression is measured.

Calculating the composite scores for each subset (S_{pred}⁽¹⁾, S_{pred}⁽²⁾ involves a step of summing the individual scores for the words of that subset. In this example, that sum is weighted by the duration of the corresponding words in the spoken expression.

In fact, if a plurality of words from the same subset are recognized from substantially the same portion of the spoken expression, there is a risk of the sum of the individual scores being relatively high. During the step (d), there is the risk of choosing this kind of subset rather than a subset that is really pertinent.

For example, a vocabulary comprises among other things a first subset comprising the words “cat”, “car” and “black”, together with a second subset comprising the words “cat”, “field” and “black”. If the individual scores are binary and the expression spoken by a user is “the black cat”, the composite score of the second subset will probably be 2 and the composite score of the first subset will probably be 3. In fact, the words “cat” and “car” may be recognized from substantially the same portion of the spoken expression. There is therefore a risk of the second subset being eliminated by mistake.

Simply summing the durations potentially represents an overestimation of the real temporal coverage. Nevertheless, this approximation is tolerable in a first pass for selecting a short list of candidates if a second and more accurate pass takes account of overlaps only for the selected preferred subsets.

Moreover, if the sum of the durations of the recognized words of a subset is less than a certain fraction of the duration of the spoken expression, for example 10%, that subset may be considered not to be meaningful.

To return to the example of the table from FIG. 4, assume that a user speaks the expression: “Hello, I still have a problem, the Internet network is not working, it's really too expensive for what you get”. Step (b) of free recognition of the words from the vocabulary might recognize the words “network”, “Internet”, “is not working” and “too expensive”. The individual score of each of these words (W3, W4, W5, W6) is therefore equal to 1, whereas the individual score of each of the other words from the vocabulary (W1, W2) is equal to 0.

The durations τ of the recognized words are also measured in the step (b).

For each subset (S_{pred}⁽¹⁾, S_{pred}⁽²⁾, the values of the individual scores as weighted by the corresponding durations and the corresponding coefficients from the corresponding row are summed over the words from the vocabulary. Once again, the calculation is relatively fast.

This algorithm yields a value of 50 for the first subset S_{pred}⁽¹⁾ and a value of 53 for the second subset S_{pred}⁽²⁾. These values are relatively close and mean that the second subset cannot is not a clear choice.

In this implementation, the processor calculating the composite scores performs an additional step of weighting each composite score by a coverage Cov expressed as a number of words relative to the number of words of the corresponding subset. Thus the coverage expressed as a number of words of the first subset S_{pred}⁽¹⁾ is only 50%.

The table can therefore comprise an additional column indicating the value of the coverage Cov as a number of words for each subset. The composite score of each subset is therefore weighted by the value of that coverage expressed as a number of words. Thus the composite score of the first subset S_{pred}⁽¹⁾ is only 25, whereas the composite score of the second subset S_{pred}⁽²⁾ is 53. The second subset S_{pred}⁽²⁾ is thus a clear choice for the preferred subset.

Moreover, not all the subsets necessarily comprise the same number of words. The weighting by the coverage expressed as a number of words is relative to the number of words of the subset, which provides a more accurate comparison of the composite scores.

Weighting by other factors depending on the numbers of words of the subsets is also possible.

Selection of a Short List

FIG. 5 shows, by way of example, a flowchart of an implementation of a speech recognition method of the present invention. In particular, a speech recognition computer program product of the present invention can include instructions for effecting the various steps of the flowchart shown.

The method shown comprises the steps (a), (b), and (c) already described.

The speech recognition method of the present invention can provide for a single preferred subset to be determined, following the execution of the determination step (d), as in the examples of FIGS. 2 and 4, or for a short list of preferred subsets comprising a plurality of preferred subsets to be selected.

With a short list, a step (e) of determining a single candidate best subset S_{pred}^{(ibest)} from the short list can be applied. In particular, since this step (e) is effected over a relatively small number of subsets, algorithms that are relatively greedy of computation time may be used.

The method of the present invention furthermore retains hypotheses that might have been eliminated in a method involving only an ordered language model. For example, if a user speaks the expression “the cat is black”, the steps (a), (b), (c) and (d) retain a subset comprising the words “cat” and “black”. The use of more complex algorithms then eliminates subsets that are not particularly pertinent.

For example, the overlap of words of a subset from the short list can be estimated exactly. A start time of the corresponding spoken expression portion and an end time of that portion are measured for each word of the subset. From those measurements, the temporal overlaps of the words of the subset can be determined. The overlap between the words of the subset can then be estimated. The subset can be rejected if the overlap between two words exceeds a certain threshold.

Consider again the example of the first subset comprising the words “cat”, “car”, and “black” and the second subset comprising the words “cat”, “field” and “black”. It is again assumed that the individual scores are binary. If a user speaks the expression “the black cat is in the field”, both subsets have a composite score equal to 3. The short list therefore comprises these two subsets. The overlap of the words “cat” and “car” in the spoken expression can be estimated. Since this overlap takes a relatively high value here, the first subset can be eliminated from the short list.

Moreover, the constraint of forming a valid path in a sequential representation can be applied to the words of the subsets of the short list.

For example, the sequential representation can comprise an “NBest” representation, whereby the words of each subset from the short list are ordered along different paths. A cumulative probability can be calculated for each path. The cumulative probability can use a hidden Markov model and can take account of the probability of passing from one word to the other. By choosing the highest cumulative probability from all the cumulative probabilities of all the subsets, the candidate best subset can be determined.

For example, the short list can comprise two subsets:
“cat”, “black”, “a”; and
“back”, “a”, “car”.

Several paths are possible from each subset. Thus for the first subset:
a-black-cat;
a-cat-black;
black-a-cat;
etc.

For the second subset:
a-back-car;
back-car-a;
etc.

Here the highest cumulative probability is that associated with the path a-black-cat, for example: the candidate best subset is therefore the first subset.

FIGS. 6 and 7 illustrate two other examples of sequential representation, respectively a tree and a word diagram.

Referring to FIG. 6, a tree, also commonly called a word graph, is a sequential representation with paths defined by ordered sequences of words. The word graph can be constructed, having lines that are words and states that are times of transitions between words.

However, elaborating this kind of word graph can be time-consuming, since the transition times rarely coincide perfectly. This state of affairs can be improved by applying coarse approximations to the manner in which the transition times depend on the past.

In the FIG. 6 example, the short list comprises three subsets of four words each:
“a”, “small”, “cat”, “black”;
“a”, “small”, “cat”, “back”; and
“a”, “small”, “car”, “back”.

The constraint of forming a valid path in a word graph can be applied to the words of the subsets from the short list to determine the best candidate.

As shown in FIG. 7, a word diagram, or trellis, can also be used. A word diagram is a sequential representation with time plotted along the abscissa, and an acoustic score plotted along the ordinate.

Word hypotheses are issued with the ordering of the words intentionally ignored. A word diagram can be considered as a representation of a set of quadruplets {t1, t2, vocabulary word, acoustic score}, where t1 and t2 are respectively start and end times of the word spoken by the user. The acoustic score of each word is also known from the vocabulary.

Each word from the trellis can be represented by a segment whose length is proportional to the temporal coverage of the spoken word.

In addition to this, or instead of this, step (e) can comprise at least two steps: a step using an ordered language model and an additional step. The additional step can use a method involving a commutative language model, for example the steps (c) and (d) and/or a word diagram with no indication as to the time of occurrence of the words. Because of the small number of subsets to be compared, these steps can be executed more accurately.

Variants

The vocabulary comprises subsets of words. It can include subsets comprising only one word. Thus another example of a vocabulary is a directory of doctors' practices. Certain practices have only one doctor, whereas others have more than one doctor. Each subset corresponds to a given practice. Within each subset, the order of the words, here the names of the doctors, is relatively unimportant.

The subsets can be chosen arbitrarily and once and for all. Subsets can be created or eliminated during the lifetime of the speech recognition device. This way of managing the subsets can be arrived at through a learning process. Generally speaking, the present invention is not limited by the method of constructing the subsets. The subsets are constructed before executing steps (c) and (d).

During step (b), an individual score may be assigned to only some of the words from the vocabulary. For example, if a word from the vocabulary is recognized with certainty, one option is to scan only the words of the subsets including the recognized word, thereby avoiding recognition of useless words and thus saving execution time. Moreover, because of the relatively small number of subsets, the risks of error are relatively low.

During the step (c), the plurality of subsets can cover only some of the subsets of the vocabulary, for example subsets whose words are assigned an individual score.

The composite scores can themselves take binary values. For example, if the sum of the individual scores (where applicable weighted and where applicable globally multiplied by a coverage expressed as a number of words) reaches a certain threshold, the composite score is made equal to 1. The corresponding subset is therefore a preferred subset.

1. A speech recognition method comprising for a spoken expression (SE):
a) providing a vocabulary (61) of words including predetermined subsets (S_{pred}⁽ⁱ⁾) of words;
b) assigning each word (Wₖ) of at least one subset an individual score (S_{ind}(Wₖ)) as a function of the value of a criterion of the acoustic resemblance of said word to a portion of the spoken expression;
c) assigning to each subset of a plurality of subsets a composite score (S_{comp}(S_{pred}⁽ⁱ⁾)) corresponding to a sum of the individual scores of said words of that subset; and
d) determining at least one preferred subset having the highest composite score.

2. A method according to claim 1, wherein to each word (Wₖ) from the vocabulary (61) is assigned an individual score (S_{ind}(Wₖ)) during step (b).

3. A method according to either preceding claim, wherein the individual scores (S_{ind}(Wₖ)) take binary values.

4. A method according to claim 1 or claim 2, wherein the individual score (S_{ind}(Wₖ)) assigned to a word (Wₖ) is an acoustic score.

5. A method according to any preceding claim, characterized in that, for each composite score (S_{comp}(S_{pred}⁽ⁱ⁾)), the sum of the individual scores (S_{ind}(Wₖ)) is weighted by the duration of the corresponding words (Wₖ) in the spoken expression (SE).

6. A method according to any preceding claim, characterized in that step (d) comprises a step of weighting each composite score (S_{comp}(S_{pred}⁽ⁱ⁾)) by a coverage (Cov) expressed as a number of words relative to the number of words of the corresponding subset (S_{pred}⁽ⁱ⁾).

7. A method according to any preceding claim, comprising the selection, in step (d), of a short list comprising a plurality of preferred subsets, and including a step (e) of determining a single candidate best subset (S_{pred}^{(ibest)}).

8. A method according to claim 7, comprising, for each preferred subset from the short list, estimating during step (e) the overlap of the words of said preferred subset in the spoken expression (SE).

9. A method according to claim 7, comprising, for each preferred subset from the short list, applying to words of said preferred subset, a constraint of forming a valid path in a sequential representation during a step (e).

10. A method according to claim 9, wherein the sequential representation comprises a diagram of the words of the preferred subsets with time on the abscissa axis and an acoustic score on the ordinate axis.

11. A method according to claim 9, wherein the sequential representation comprises a tree with paths defined by ordered sequences of preferred subsets.

12. A vocabulary-based speech recognition computer program product, the computer program being intended to be stored in a memory of a central unit (2) and/or stored on a memory medium intended to cooperate with a reader (10a, 10b) of said central unit and/or downloaded via a telecommunications network (12), characterized in that, for a spoken expression, it comprises instructions for:
consulting a vocabulary of words including predetermined subsets of words;
assigning to each word of at least one subset an individual score as a function of the value of a criterion of acoustic resemblance of said word to a portion of the spoken expression;
for a plurality of subsets, assigning to each subset of the plurality of subsets a composite score corresponding to a sum of the individual scores of the words of said subset; and
determining at least one preferred subset having the highest composite score.

13. A speech recognition device comprising, for a spoken expression:
means (6) for storing a vocabulary comprising predetermined subsets of words;
identification means for assigning to each word of at least one subset an individual score as a function of the value of a criterion of resemblance of said word to at least one portion of the spoken expression;
calculation means (8) for assigning to each subset of a plurality of subsets a composite score corresponding to a sum of the individual scores of the words of said subset; and
means for selecting at least one preferred subset with the highest composite score.
